(19) United States
(12) Patent Application Publication
(10) Pub. No.: US 2003/0031088 A1
(43) Pub. Date: Feb. 13, 2003

(54) Apparatus and method for agitating a fluid suspension

(76) Inventor: Richard D. Baron, Zephyrhills, FL (US)

Correspondence Address: John C. Clark, Carlton Fields, P.A., P.O.Box 3239, Tampa, FL, 33601-3239, US

(21) Appl. No.: 09/925,998

(22) Filed: Aug. 9, 2001

(51) Int. Cl. B01F 11/00

(52) U.S. Cl. 366/204; 366/197

(57) ABSTRACT

This invention provides an apparatus and a method for agitating a fluid suspension contained within an at least partially flexible vessel. This invention provides an apparatus comprising a structure for receiving the vessel, an agitating member capable of receiving the vessel, and a motor operatively communicating with the agitating member to substantially uniformly agitate the fluid suspension. This invention also provides a method comprising folding an at least partially flexible vessel so that there are two inner portions and reciprocally moving one or both of the inner portions between a first position and a second position, whereby the fluid suspension is substantially uniformly agitated.

### BACKGROUND OF THE INVENTION

This invention relates generally to the beverage industry, and more particularly to an apparatus and method for agitating a fluid suspension so that the fluid suspension is uniformly agitated and mixed, contained in a vessel for dispensing portions of the suspension.

The need to substantially uniformly agitate fluid suspensions for dispensing has long been felt. In the beverage industry, it is desirable to dispense beverages with consistent quality among all beverages dispensed. In order to ensure consistent quality, the sediment within the fluid suspension being dispensed must be thoroughly and uniformly agitated and mixed. If the fluid suspension is not properly agitated, then the beverage dispensed will contain an improper amount of suspended material. For example, if an orange juice dispenser does not adequately agitate the vessel containing the orange juice, some glasses of juice dispensed will contain more pulp than other glasses of juice dispensed from the same dispenser.

Methods for agitating fluid suspensions are well known in the art. Some have attempted to blend the contents of a bag using an actuator to reciprocally exert and release pressure upon a single portion of a flexible container. However, such methods do not adequately or uniformly agitate the fluid suspensions. Applying pressure to only a portion of the vessel simply displaces the suspended materials away from the point of pressure. Typically, this forces the suspended materials to the corners of the vessel, so that the fluid suspension is not substantially uniformly agitated. Therefore, an apparatus and method are needed that substantially uniformly agitates a fluid suspension.

### SUMMARY OF THE INVENTION

This invention provides an apparatus and a method for agitating a fluid suspension contained within an at least partially flexible vessel. This invention provides an apparatus comprising a structure for receiving the vessel such that a portion of the vessel rests proximate to one side of an agitating member and another portion of the vessel rests proximate to another side of the agitating member, and a motor operatively communicating with the agitating member to substantially uniformly agitate the fluid suspension. This invention also provides a method comprising folding an at least partially flexible vessel so that there are two inner portions and reciprocally moving one or both of the inner portions between a first position and a second position, whereby the fluid suspension is substantially uniformly agitated.

### BRIEF DESCRIPTION OF THE DRAWINGS

A particularly preferred embodiment of the invention will be described in detail below in connection with the drawings in which:

FIG. 1 is an example of an apparatus of the prior art;

FIG. 2 is an example of the flow of suspended material as a result of a prior art apparatus;

FIG. 3 is an example of the flow of suspended material as a result of a prior art apparatus;

FIG. 4 is a perspective view of a structure of this invention in a loading position;

FIG. 5 is a perspective view of an at least partially flexible vessel and fluid suspension;

FIG. 6 is a perspective view of a structure of this invention in an operating position;

FIG. 7 is a side view of an at least partially flexible vessel and fluid suspension;

FIG. 8 is a perspective view of one preferred structure of this invention;

FIG. 9 is a side view of one preferred structure of this invention;

FIG. 10 is a perspective view of a dispensing tube and a passage operatively associated;

FIG. 11 is a side view of an at least partially flexible vessel and fluid suspension, illustrating the manner in which a fluid suspension may be substantially uniformly agitated;

FIG. 12 is a side view of an at least partially flexible vessel and fluid suspension, illustrating the manner in which a fluid suspension may be substantially uniformly agitated;

FIG. 13 is a flow chart illustrating a preferred method of this invention; and

FIG. 14 is a flow chart illustrating a preferred method of this invention.

### DESCRIPTION OF PREFERRED EMBODIMENTS

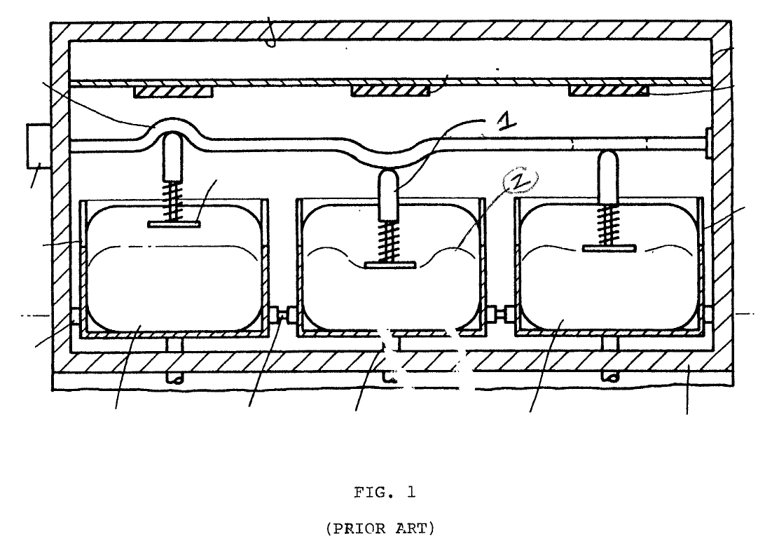

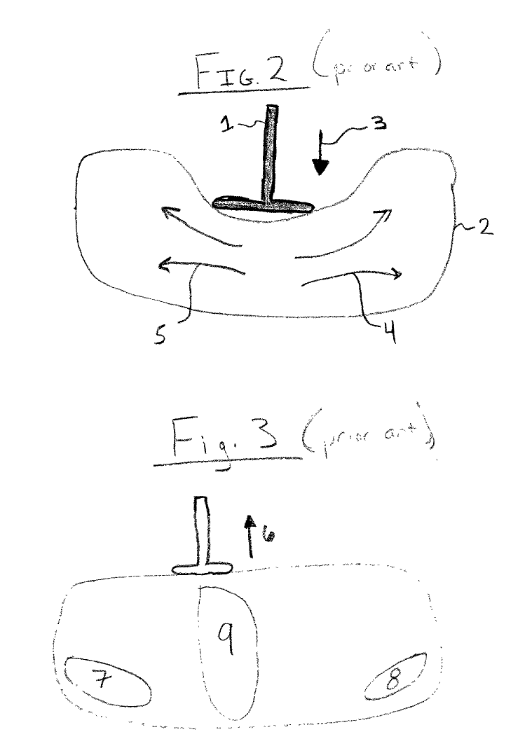

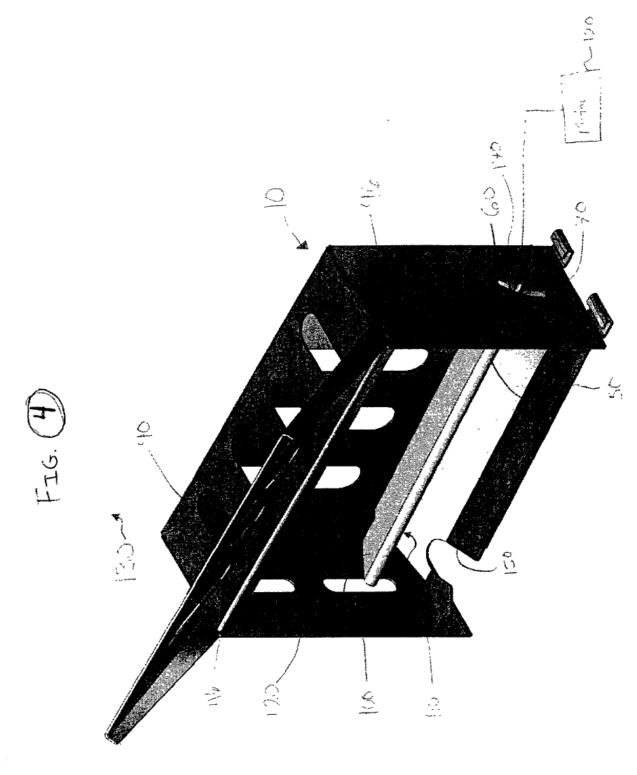

In the prior art, as illustrated in FIGS. 1-3, an actuator 1 reciprocally depresses and releases a bag 2. The pressure 3 by the actuator 1 forces the suspended material in the bag 2 to travel in directions 4 and 5, away from the center of the bag 2 and towards the sides of the bag 2. When the actuator releases in a direction 6, the suspended material settles in areas 7 and 8, with little suspended material in area 9. As a result, beverages dispensed from the bag 2 are not uniform in composition.

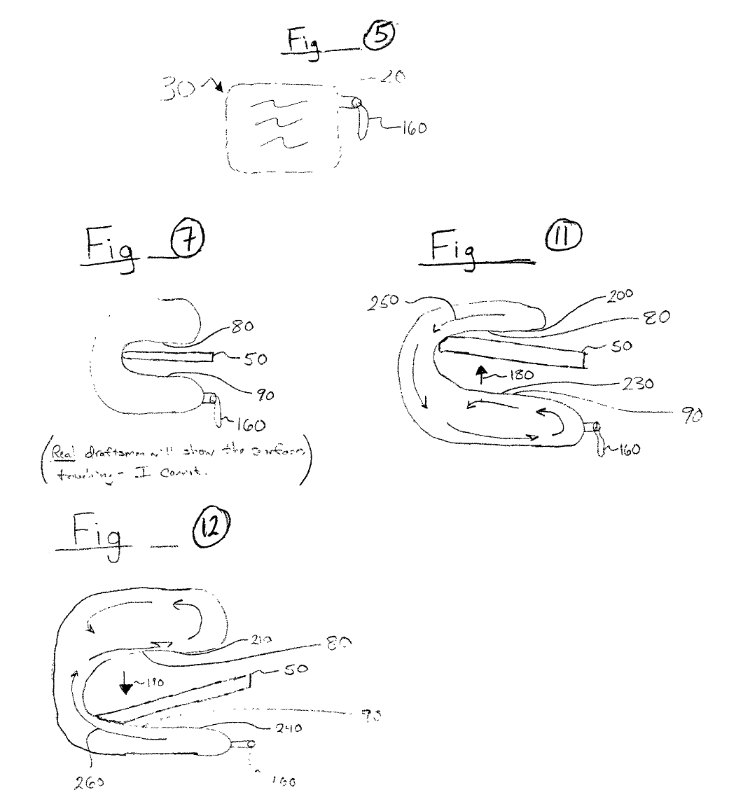

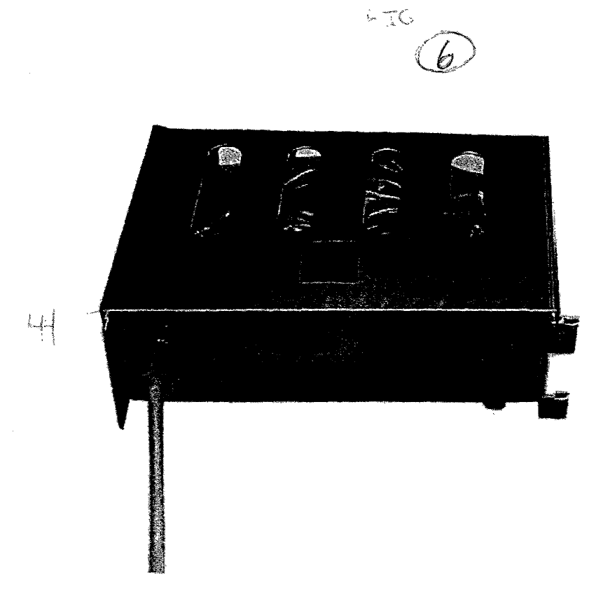

The present invention overcomes this problem in the prior art. Particularly preferred embodiments of the present invention are illustrated in the drawings, which illustrate a preferable apparatus and method for agitating fluid suspensions contained within an at least partially flexible vessel. FIGS. 4 and 5 illustrate an apparatus generally indicated by reference numeral 10, for agitating a fluid suspension 20 contained within an at least partially flexible vessel 30. In one preferred embodiment, the at least partially flexible vessel 30 is completely flexible. Suitably, the apparatus has a structure 40 for receiving the at least partially flexible vessel 30. In one preferred embodiment, the structure 40 is temperature controlled using any device or method that is well known in the art. Suitably, the structure 40 may be refrigerated or heated. As shown in FIGS. 4 and 6, the structure is suitably adjustable between a first loading position 42, where the vessel may be conveniently removed from or inserted into the structure 40, and a second operating position 44, where the vessel 30 is retained within the structure 40 in a position suitable for an agitating member 50 to substantially uniformly agitate the fluid suspension. Conveniently, hinges 46 adjust the structure 40 between the first loading position 42 and the second operating position 44.

Preferably, the structure 40 has an agitating member 50 operatively located within the structure 40, and the agitating member 50 is suitably movable between a first position 60 and a second position 70. As illustrated in at FIGS. 4 and 7, the at least partially flexible vessel 30 is conveniently positioned such that a first inner portion 80 rests substantially proximate to a first side 100 of the agitating member 50. Likewise, a second inner portion 90 of the at least partially flexible vessel 30 rests substantially proximate to a second side 110 of the agitating member 50.

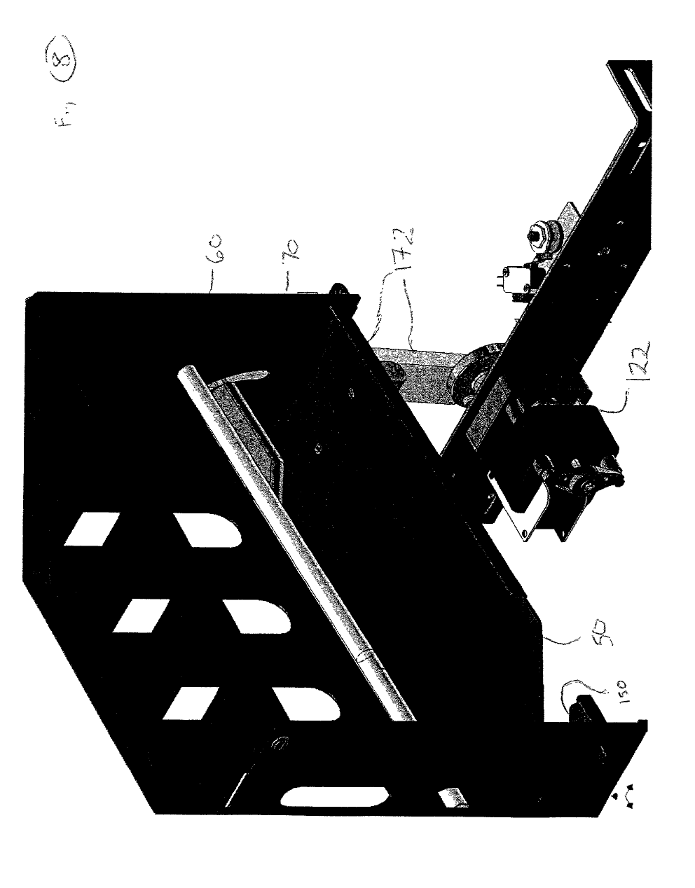

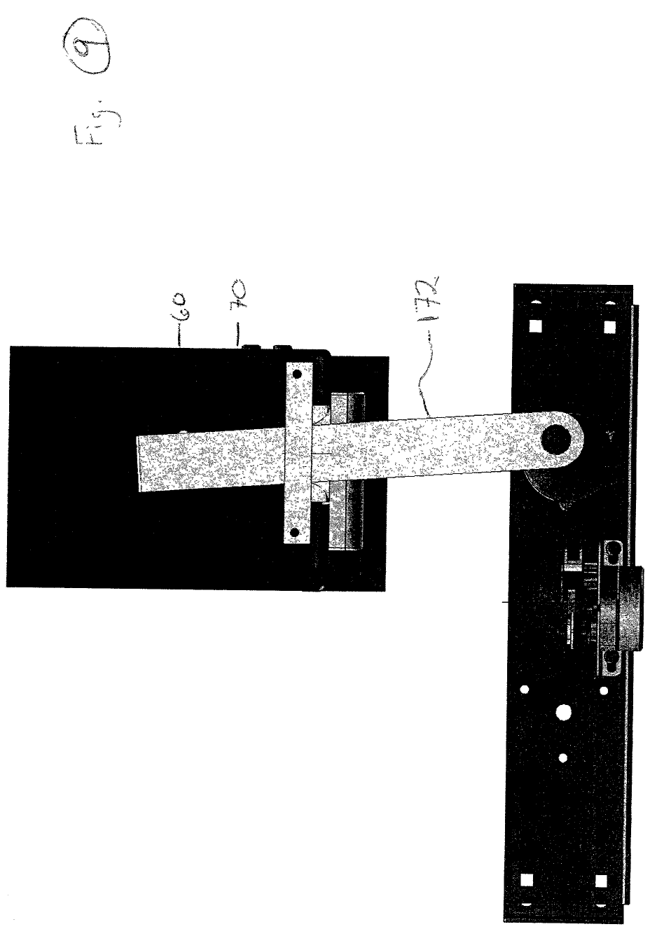

Conveniently, a motor 120, herein illustrated by a rectangle representing any device to impart motion known in the art, including motion imparted through manual operation, is operatively communicated to the agitating member 50. Most preferably, the motor 120 operatively communicates with the agitating member 50 through a linkage 170. FIG. 8 illustrates a preferred motor 122 and a preferred linkage 172. FIG. 9 illustrates the linkage 172 from a side view. When in operation, the motor 120 suitably causes the agitating member 50 to move between the first position 60 and the second position 70 to substantially uniformly agitate the fluid suspension 20. In one preferred embodiment, the motor 122 imparts reciprocal motion to the agitating member 50 by moving the linkage 172 and agitating motion to a first position 60 and a second position 70.

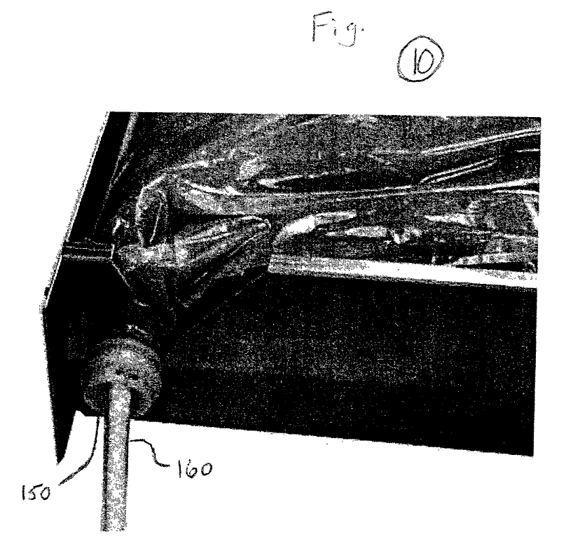

In a preferred embodiment, the structure 40 defines an inner space 120 of the structure and an outer space generally represented by the reference numeral 130. Conveniently, a passage 150 is disposed between the inner space 120 and the outer space 130 of the structure 40. The passage 150 is utilized in dispensing the fluid suspension 20 from the inner space 120 to the outer space 130 of the structure 40. As shown in FIG. 10, the at least partially flexible vessel 30 suitably has a dispensing tube 160 that is operatively associated with the passage 150 for dispensing the fluid suspension 20 from the inner space 120 to the outer space 130 of the structure 40.

As illustrated in FIG. 7, to perform a particularly preferred method of this invention for agitating fluid suspensions contained within an at least partially flexible vessel, the at least partially flexible vessel 30 is folded such that there is an inner first portion 80 and an inner second portion 90. Looking at FIGS. 11 and 12, the agitating member 50 reciprocally moves the inner first portion 80 between a first position 200 and a second position 210. Suitably, the agitating member 50 also reciprocally moves the inner second portion 90 between a first position 230 and a second position 240. This reciprocal motion conveniently substantially uniformly agitates the fluid suspension 20.

FIGS. 5, 11, 12, and 13 also illustrate the manner in which a preferred apparatus 10 and method 269 of this invention substantially uniformly agitates the fluid suspension 20. Looking at FIG. 11, the agitating member 50 exerts a force 180 on the inner first portion 80 of the at least partially flexible vessel 30, causing the inner first portion to travel to the first position 200. This movement causes the fluid suspension 20 to travel in a direction generally referred to by the reference numeral 250. Preferably, as a result of the agitation of the fluid suspension 20, the inner second portion 90 of the at least partially flexible vessel 30 travels to a first position 230.

Conveniently, the agitating member then exerts a force 190 on the inner second portion 90 of the at least partially flexible vessel 30, causing the inner second portion 90 to reciprocally move from the first position 230 to a second position 240. Suitably, the inner first portion 80 reciprocally moves from the first position 200 to a second position 210. The fluid suspension 20 preferably travels in a direction generally referred to by reference numeral 260. As a result of this reciprocal motion, the fluid suspension is substantially uniformly agitated.

In one preferred embodiment of the method of this invention, the at least partially flexible vessel 30 is loaded into a structure 40 for dispensing the fluid suspension 40. Structure 40 suitably defines an inner space 120 and an outer space 130 and has a passage disposed between the inner space 120 and the outer space 130 of the structure 40. A preferred method of this invention temperature controls the structure 40. In a preferred embodiment of the method of this invention, the at least partially flexible vessel 30 loaded into the structure 40 has a dispensing tube 160. Conveniently, a user of a method of this invention operatively associates the dispensing tube 160 with the passage 150 of the structure 40. As a final preferred act of the present invention, the fluid suspension is dispensed from the structure 40.

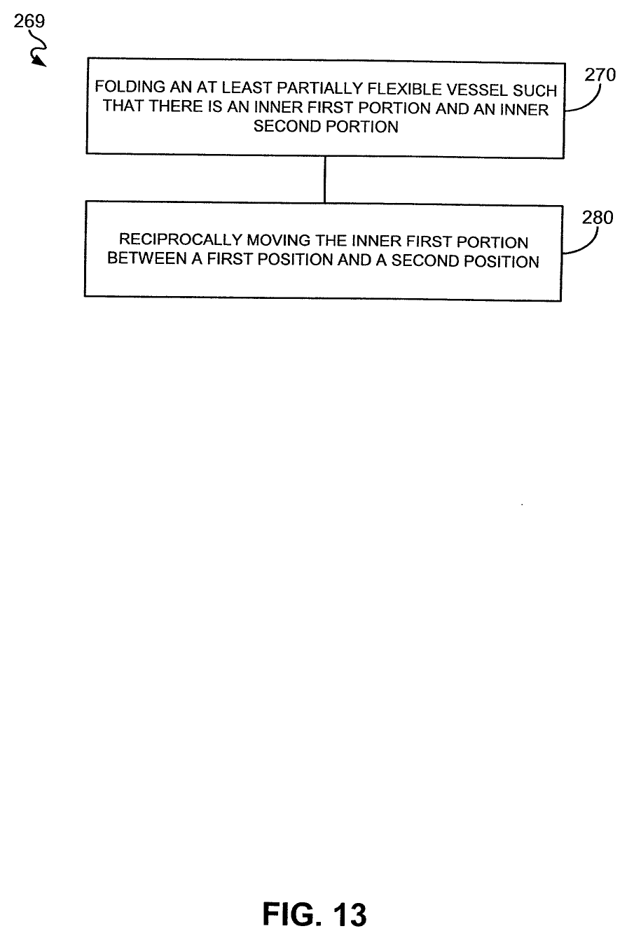

A preferred method 269 is illustrated in FIG. 13. Suitably, an act 270 is folding an at least partially flexible vessel such that there is an inner first portion and an inner second portion. Conveniently, another act 280 is reciprocally moving said inner first portion between a first position and a second position; whereby said fluid suspension is substantially uniformly agitated within said at least partially flexible vessel.

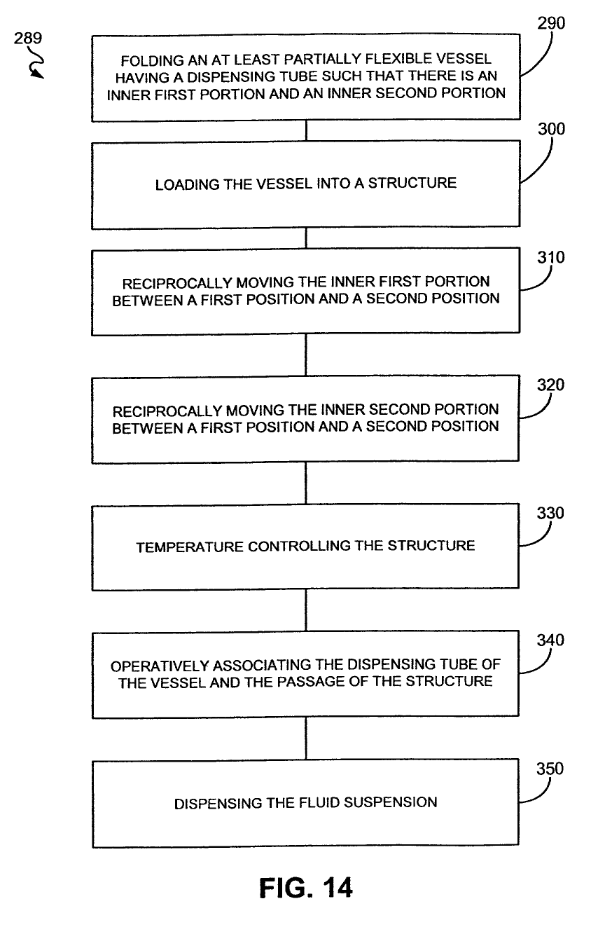

FIG. 14 illustrates another preferred method 289 of the present invention. An act 290 is, preferably, folding an at least partially flexible vessel having a dispensing tube such that there is an inner first portion and an inner second portion. Another convenient act 300 is loading the vessel into a structure. Preferably, this structure defines an inner space of the structure, an outer space of the structure, and a passage disposed between the inner space and the outer space for dispensing a fluid suspension. Suitably, an act 310 is reciprocally moving the inner first portion between a first position and a second position; whereby the fluid suspension is substantially uniformly agitated within the at least partially flexible vessel. An act 320 is reciprocally moving the inner second portion between a first position and a second position. In a preferred method, another act 330 is temperature controlling the structure by any device or method well known in the art. An act 340 is operatively associating the dispensing tube of the vessel and the passage of the structure. Conveniently, an act 350 is dispensing the fluid suspension. It should be noted that these are acts for one preferred embodiment of the present invention, and the actual order of the steps is not critical to the invention.

What is claimed is:

1. An apparatus for agitating a fluid suspension contained within an at least partially flexible vessel, comprising:
a structure for receiving the at least partially flexible vessel;
an agitating member movable between a first position and a second position operatively located within said structure such that said at least partially flexible vessel may be received with an inner first portion of said flexible vessel resting substantially proximate to a first side of said agitating member and an inner second portion of said flexible vessel resting substantially proximate to a second side of said agitating member; and
a motor operatively communicating with said agitating member; whereby said agitating member reciprocally moves between said first position and said second position to substantially uniformly agitate said fluid suspension.

2. The apparatus of claim 1, wherein said structure is temperature controlled.

3. The apparatus of claim 2, wherein said structure is adjustable between a first loading position and a second operating position.

4. The apparatus of claim 2, wherein said vessel is completely flexible.

5. The apparatus of claim 3, wherein said vessel is completely flexible.

6. The apparatus of claim 1, wherein said structure is adjustable between a first loading position and a second operating position.

7. The apparatus of claim 6, wherein said vessel is completely flexible.

8. The apparatus of claim 1, wherein said vessel is completely flexible.

9. The apparatus of claim 1, wherein said structure defines an inner space of said structure and an outer space of said structure, and a passage is disposed between said inner space and said outer space for dispensing said fluid suspension from said inner space to said outer space.

10. The apparatus of claim 9, wherein said at least partially flexible vessel has a dispensing tube.

11. The apparatus of claim 11, wherein said passage and said dispensing tube are operatively associated for dispensing said fluid suspension from said inner space to said outer space.

12. The apparatus of claim 1, wherein said at least partially flexible vessel has a dispensing tube.

13. The apparatus of claim 1, wherein said motor operatively communicates with said agitating member through a linkage.

14. An apparatus for agitating a fluid suspension contained within a completely flexible vessel, said vessel having a dispensing tube and being operatively associated with a passage, comprising:
a temperature controlled structure for receiving the at least partially flexible vessel, said structure being adjustable between a first loading position and a second operating position, said structure defining an inner space of said structure and an outer space of said structure, and said structure having said passage disposed between said inner space and said outer space for dispensing said fluid suspension from said inner space to said outer space;
an agitating member movable between a first position and a second position operatively located within said structure such that said at least partially flexible vessel may be received with an inner first portion of said flexible vessel resting substantially proximate to a first side of said agitating member and an inner second portion of said flexible vessel resting substantially proximate to a second side of said agitating member; and
a motor operatively communicating with said agitating member through a linkage; whereby said agitating member reciprocally moves between said first position and said second position to substantially uniformly agitate said fluid suspension.

15. A method for agitating a fluid suspension contained within an at least partially flexible vessel, comprising:
folding said at least partially flexible vessel such that there is an inner first portion and an inner second portion; and
reciprocally moving said inner first portion between a first position and a second position; whereby said fluid suspension is substantially uniformly agitated within said at least partially flexible vessel.

16. The method of claim 15, further comprising the act of reciprocally moving said second inner portion between a first position and a second position.

17. The method of claim 16, further comprising the act of loading said at least partially flexible vessel into a structure.

18. The method of claim 16, further comprising the act of temperature controlling said structure.

19. The method of claim 16, further comprising the act of dispensing said fluid suspension.

20. The method of claim 17, further comprising the act of temperature controlling said structure.

21. The method of claim 17, further comprising the act of dispensing said fluid suspension.

22. The method of claim 18, further comprising the act of dispensing said fluid suspension.

23. The method of claim 20, further comprising the act of dispensing said fluid suspension.

24. The method of claim 15, further comprising the act of loading said at least partially flexible vessel into a structure.

25. The method of claim 24, further comprising the act of temperature controlling said structure.

26. The method of claim 24, further comprising the act of dispensing said fluid suspension.

27. The method of claim 25, further comprising the act of dispensing said fluid suspension.

28. The method of claim 15, further comprising the act of temperature controlling said structure.

29. The method of claim 28, further comprising the act of dispensing said fluid suspension.

30. The method of claim 15, further comprising the act of dispensing said fluid suspension.

31. The method of claim 15, further comprising the act of loading said at least partially flexible vessel into a structure, said structure defining an inner space of said structure and an outer space of said structure and a passage disposed between said inner space and said outer space for dispensing said fluid suspension.

32. The method of claim 31, further comprising the act of loading an at least partially flexible vessel having a dispensing tube into said structure.

33. The method of claim 32, further comprising the act of operatively associating said dispensing tube and said passage.

34. The method of claim 33, further comprising the act of dispensing said fluid suspension.

35. A method for agitating a fluid suspension contained within an at least partially flexible vessel having a dispensing tube, comprising:
folding said at least partially flexible vessel such that there is an inner first portion and an inner second portion;
loading said at least partially flexible vessel into a structure, said structure defining an inner space of said structure and an outer space of said structure and a passage disposed between said inner space and said outer space for dispensing said fluid suspension;
reciprocally moving said inner first portion between a first position and a second position; whereby said fluid suspension is substantially uniformly agitated within said at least partially flexible vessel;
reciprocally moving said inner second portion between a first position and a second position;
temperature controlling said structure;
operatively associating said dispensing tube and said passage; and
dispensing said fluid suspension.
